(19) United States
(12) Patent Application Publication
(10) Pub. No.: US 2024/0070157 A1
(43) Pub. Date: Feb. 29, 2024

(54) System and Method for Email Address Selection

(71) Applicant: LiveRamp, Inc., San Francisco, CA (US)

(72) Inventor: Pavan Marupally, Conway, AR (US)

(21) Appl. No.: 17/766,471

(22) PCT Filed: Oct. 2, 2020
(86) PCT No.: PCT/US20/54106

§ 371 Date: Apr. 4, 2022

Related U.S. Application Data
(60) Provisional application No. 62/911,259, filed on Oct. 5, 2019.

(51) Int. Cl. G06F 16/2457

(52) U.S. Cl. CPC G06F 16/24578; G06F 16/24573

(57) ABSTRACT

A system for selecting a best email address aggregates all evidence about the emails associated with a consumer utilizing an identity graph. This evidence is used to make a choice concerning the best email address by applying processing engines. The evidence may include point-in-time (PIT) signals; temporal date signals; recency; source contribution; the URL provider; overlapping of the local email portion with a consumer's name; and the number of people in the household of that consumer who share the same local email address portion. The presence of profanity in the local portion of an email address may also be used by a profanity engine in determining whether an email address is or is not the best email address, and tiebreakers may be used by a tiebreaking engine when there are two or more email addresses that are scored closely.

### CROSS-REFERENCE TO RELATED APPLICATIONS

This application claims priority to U.S. Provisional Patent Application No. 62/911,259, filed on Oct. 5, 2019. Such application is incorporated by reference herein in its entirety.

### BACKGROUND OF THE INVENTION

The field of the invention is the identification and selection of the best email address for use in contacting a person.

The vast majority of people living in developed countries today have one or more email addresses through which they may be contacted. But it is not uncommon for a person to have multiple email addresses, such as when a person uses an email for work and an email for personal communications. Many people may maintain multiple personal emails in order to separate their communications depending upon the context; for example, a person may have an email address that is used only with close friends and family, an email for use with online shopping, and one or more emails used with particular on-line groups such as groups associated with hobbies, politics, or other interests. Many people maintain specific email addresses for communicating with parties from whom the user expects to receive unwanted “spam” email; in this way, the user segregates the unwanted email messages in an email inbox that the user checks infrequently if at all. Many times, a user will have one or more active email addresses that the user has simply forgotten about due to the passage of time, such as an email address used at a school the person no longer attends. On the other hand, it also occurs that multiple people may share the same email address; this is particularly common among family members or those persons who live in the same household.

An online retailer may wish to send targeted marketing messages to a person using email. For the reasons set forth above, in addition to many other possible reasons, it is difficult to determine which email is the “best” email address for reaching a person. For purposes herein, the “best” email address is the one that most likely belongs to a person of interest and that is actively being used by that person as his or her primary email. By correctly selecting the best email address, the marketer improves the chances that the marketing message will be seen by the targeted consumer.

Marketers (which may be retailers offering a product or service, or the advertising agencies that work for them) often turn to marketing services providers in order to improve their success with marketing campaigns, including targeted email marketing campaigns. The service provider then seeks to provide the best email address for a particular targeted consumer back to its client in order to improve the results of the marketing campaign, and thereby provide the greatest value to its client. Some such service providers maintain an “identity graph” in order to provide their services most effectively. For purposes herein, an “identity graph” may be defined as a database that stores identifiers and/or devices that correlate with individual consumers. These identifiers can take many forms. For example, identifiers may be actual names; addresses; telephone numbers; email addresses; online user names, cookies stored on browsers such as those that run on personal computers, smartphones, tablets, and many other electronic devices; loyalty card numbers; and so on. Devices associated with a consumer may be personal computers, smartphones, addressable televisions, and many other devices that this consumer uses either exclusively or shares with others. It may be noted that some of these identifiers are online identifiers, but some may be offline as well. Knowledge of both online and offline identifiers may allow the marketing services provider to match, for example, offline advertising and offline purchases to determine the overall effectiveness of an online marketing campaign. Still other information may be included in an identity graph, such as various types of metadata. The metadata may include attributes that pertain to identifiers and devices, such as recency (i.e., how recently a device or identifier has been used by the consumer); activity (i.e., how often the device or identifier is used by the consumer); and household formations (i.e., how many and which people share devices or identifiers with the consumer). All of these various identifiers and/or devices plus metadata are connected together in the identity graph, so that the service provider can develop a more comprehensive view of a particular consumer to enable such functionality. The identity graph may be based on data and metadata collected by the marketing services provider, but most often the marketing service provider receives data from one or more third parties who contribute particular types of data in a data sharing arrangement so that the marketing services provider can make its own identity graph more complete.

Using identity graph technology, a marketing services provider may greatly improve the ability of a marketer to target a marketing message, and thus increase the return on investment (ROI) for its client. A marketer may have various types of information about its customers that is gained from interactions with that customer. But this data may have large gaps, or it may be “siloed” by being spread across different data storage systems maintained by the marketer. For example, a marketer may have some data about a consumer in its online sales system database, and other data about that consumer in its advertising platform software data store, and may not even realize that the two sets of records for this customer actually pertain to the same consumer. Using its identity graph, a marketing services provider can perform identity resolution, which is the process of matching and linking consumer records from such disparate sources so that the marketer has a more holistic view of its customers. This information allows the marketer to provide more individualized targeted marketing messages to its customers. Because the marketer can better understand its total relationship with a particular customer, it can recognize the value of that customer to the marketer and may, for example, provide particular discounts or other offers or perks to those consumers who it now recognizes as its most loyal customers. It may be seen that an identity graph may contain one or more email addresses for a particular consumer, but the problem remains to identify a best email address for any particular consumer so that the consumer is more likely to actually be exposed to the desired marketing message. A better system and method for identifying a best email address for a particular consumer, using an identity graph and other such technological resources available to a marketing services provider, is therefore desirable.

References mentioned in this background section are not admitted to be prior art with respect to the present invention.

### BRIEF SUMMARY OF THE INVENTION

The present invention is directed to a system and method for selecting a best email address for a particular consumer or household. First, the marketing services provider aggregates all evidence about the emails associated with a consumer, including, in certain implementations, information from an identity graph. Second, this evidence is used to make a choice concerning the best email address. In various embodiments of the invention, the aggregated evidence may include some or all of the following, possibly with the addition of other information: point-in-time (PIT) signals (i.e., the first and last time a data provider recorded this particular data); temporal date signals (i.e., trends in the PIT signals); recency (i.e., how recently the email address was reported); source contribution (i.e., how many and which data providers reported that particular email address); the URL provider (i.e., what is the URL that originated the particular email address); overlapping of the local email portion with a consumer's name (i.e., part or all of a consumer's actual name is found within the email address, which may include various techniques such as a blend of edit distance, partial/fuzzy/phonetic matching, looking for common sequences of intersecting strings, and looking for the longest common sequence of intersecting patterns); and the number of people in the household of that consumer who share the same local email address portion. In certain implementations, the presence of profanity in the local portion of an email address may also be used in determining whether an email address is or is not the best email address, and tiebreakers may be used when there are two or more email addresses that are scored closely.

These and other features, objects and advantages of the present invention will become better understood from a consideration of the following detailed description of the preferred embodiments in conjunction with the drawings as described following:

### BRIEF DESCRIPTION OF THE SEVERAL VIEWS OF THE DRAWINGS

FIG. 1 is an identity graph according to an implementation of the invention.

FIG. 2 is a data flow diagram depicting a method according to an implementation of the invention.

FIG. 3 is an architectural diagram of a system according to an implementation of the invention.

FIG. 4 is a data flow diagram depicting a method according to an alternative implementation of the invention.

### DETAILED DESCRIPTION OF THE PREFERRED EMBODIMENT(S)

Before the present invention is described in further detail, it should be understood that the invention is not limited to the particular embodiments described in any section of the specification, and that the terms used in describing the particular embodiments are for the purpose of describing those particular embodiments only, and are not intended to be limiting, since the scope of the present invention will be limited only by the claims in a subsequent nonprovisional patent application.

An identity graph may be defined as a data structure that links identifiers associated with objects. In certain cases, the objects may be individual persons (consumers) or households. These identifiers include various forms of personally identifiable information (PII), such as name, address, telephone numbers, and the like. It may also include digital identities such as email addresses, usernames, Internet protocol (IP) addresses, browser cookies, and the like. Identity graphs may also link all other information known about particular objects, which may include demographic, geographic, behavioral, purchase history, and other relevant data about an object such as a consumer or household of consumers. In addition, the identity graph may include metadata about the various data stored in the graph, such as the source of the data; timestamps for when the data was received or added. All of this information is linked together so that it may be easily accessed and used for various purposes; in the case of consumers, this information may be used to structure and send a targeted marketing message to the consumer or to a group of consumers (an audience) that have similar characteristics. Identity graphs may allow marketers to recognize persons regardless of the device they are using in order to interact with a digital property and regardless of the particular user name or other identifier they may be employing at the time. This approach thus provides a superior solution to tracking a device, because a single user uses multiple devices and multiple people may use the same device. Likewise, this approach is superior to relying only on browser cookies, since cookies aren't persistent over time and were never designed to be linked to a particular person rather than to a particular browser.

FIG. 1 provides a simplified example of an identity graph 1000 that may be employed in connection with an implementation of the invention. It should be noted that in real-world applications, identity graph 1000 may be extremely large. In one implementation, identity graph 1000 may include data pertaining to 1.8 billion people and 800 million households, and occupy 200 TB of digital data storage. Regardless of size, however, a persistent link 1010 is used to connect all of the information stored in the graph about a particular object, such as a consumer. This link may be any sort of identifier, such as an alphanumeric string, that uniquely is associated with a particular object among the universe of all possible objects. It links together PII 1012 concerning the object, purchase history 1016, access devices 1018, and demographic data 1020. The various metadata as previously described for PII 1012 is shown at metadata 1014, although metadata may be associated not just with PII 1012 but with any or all of the types of data stored in identity graph 1000.

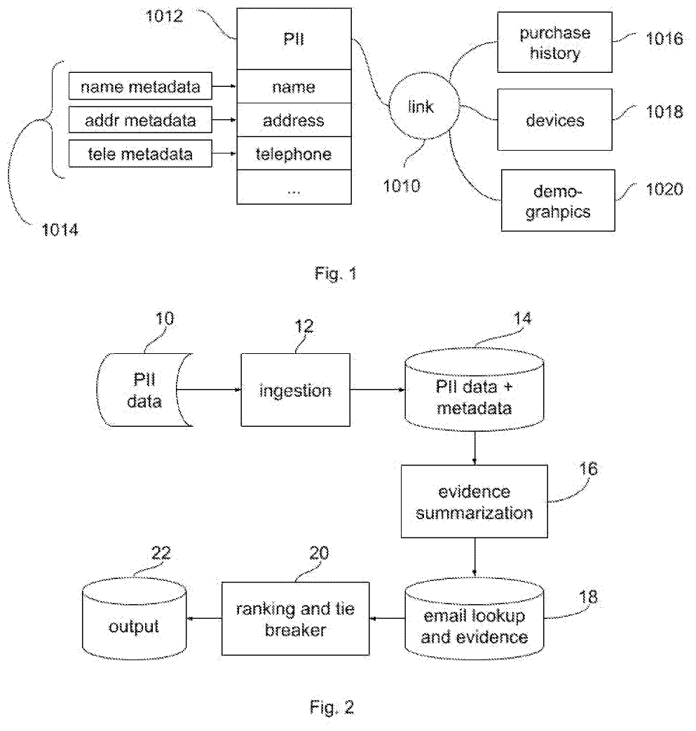

In a particular implementation of the invention as illustrated by the flow diagram of FIG. 2, a best email address may be determined using PII data drawn from identity graph 1000 at step 10. The PII data is ingested into the system at step 12, and combined with metadata from identity graph 1000 at step 14 by means of a metadata engine. The metadata of particular interest here is metadata relevant to the decision concerning choice of an email address for a marketing message. A new database is constructed by associated the PII and the metadata. The types of metadata collected may include point-in-time (PIT) signals, which may be, for example, the timestamp for the first and last time a data provider recorded this particular data. The metadata may further include temporal date signals, that is, trends in the PIT signals. Alternatively, temporal date signals may be replaced with temporary date signals in order to simulate a link with audit temporal signals over a period of time. The metadata may further include recency data, that is, how recently a particular email address was reported. The metadata may further include source contribution data, that is, how many and which data providers reported that particular email address. The metadata may further include the URL provider from which the particular email address originated. The metadata may further include an indication of whether there is overlapping of the local email portion with a consumer's name, that is, whether part or all of a consumer's actual name is found within the email address, which may include various techniques such as a blend of edit distance, partial/fuzzy/phonetic matching, looking for common sequences of intersecting strings, and looking for the longest common sequence of intersecting patterns. The metadata may further include domain overlap or strength. The metadata may further include the number of people in the household of that consumer who share the same local email address portion.

At step 16, the evidence summarization occurs by which the various factors from the metadata are applied to each candidate email address. The result of this process is stored in the email lookup and evidence database 18, with each email address being linked in a record with a set of true/false or Boolean flags. Each flag indicates whether a particular piece of evidence met some level of data quality. For example, a recency flag may be set to true if the email address was shown as reported within the last year. The evidence database 18 is then provided to the next step of ranking and tie breaking at block 20. Tie breaking is only performed if multiple email addresses end up with the same score after the flags in the email lookup and evidence database 18 are compared. The output database 22 then returns the best email address for each object (consumer, etc.) that was being examined within the identity graph 1000.

In a particular test, a first version of the method was applied to a group of 344,159,753 distinct consumers for which data was found in identity graph 1000. Of that group, it was found that, among those consumers for whom an email address was found, roughly 48% of the consumers had only one email address in the identity graph, while 52% of the consumers had more than one email address. Out of the 179,326,168 consumers with more than one email address, without using a feedback loop to compare back to a champion during the first month, the results were as follows:
112,929,864 consumers had their best email picked from the strong category (i.e., about 62%)
32,874,862 consumers had their best email picked from the moderate category (i.e., about 18%)
33,521,442 consumers had their best email picked from the weak category (i.e., about 18%)

In looking at these results, it was determined that improvements could be made with additional processing. First, a step was added to check for profanity in the local portion of an email address, which was combined with other evidence to return a better pick when there are alternatives available (e.g., an email address that contains profanity and one that does not). In addition, tie breakers were added to fine-tune the method, in order to return a better pick when there are close alternatives available.

In order to identify profanity, a “salacious engine” was built. An input into the salacious engine began with a base profanity list of about five hundred profane words, and then the list was dynamically expanded by looking for different variations of these words, using edit, partial, fuzzy, phonetic, common subsequences, and related techniques. The profanity check takes place in context with other evidence, e.g., PIT, temporal sources contribution, URL, and overlapping of the local part of an email with a consumer's name. The profanity check is fine-tuned to minimize false positives and minimize false negatives by considering misspellings, phonetic spelling differences, missing profanity components, out-of-order components, omission of letters, interchange of vowels, etc.

With respect to the tiebreakers, all pieces of evidence are considered equally with no bias or weights initially, but are revised at the end, before picking the best email address. If the strength, frequency of PIT, temporal, recency, and URL signals for multiple email choices are close to each other, then a best pick is determined using the following tiebreaker factors:
Higher amount of overlap between email address local portion and a consumer name
If email choices have similar amounts of overlap, then an email with no profanity is chosen
If all best email choices have no profanity, a best pick that has higher locality overlapping strength is chosen
If every email choice meets the above-mentioned tiebreaking situations, a best pick that is shared by a larger number of people in the household is chosen

By applying the profanity testing and tiebreakers described above, the method was applied to the same group of distinct consumers as described above. This was also performed without a feedback loop to compare back to a champion for the first month. The results were as follows:
112,938,969 consumers had their best email picked from the strong bucket/category (i.e., about 63%)
33,046,235 consumers had their best email picked from the moderate bucket/category (i.e., about 18.42%)
33,347,155 consumers had their best email picked from the weak bucket/category (i.e., about 18.59%)

Although it may be seen that the distributions vary by relatively small amounts (about 0.5%) compared to the earlier iteration, the rankings of the best pick along with the rest of the email address choices has improved and is more defensible.

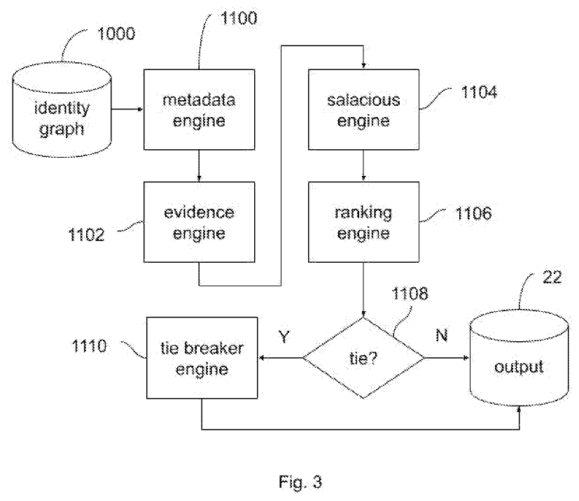

A system to implement the method of FIG. 2 is shown in FIG. 3. Each of the subroutines or “engines” are implemented on computing hardware, which may be either hosted locally or in a cloud computing environment using virtual machines. Identity graph 1000 provides data to the metadata engine 1100, which is configured to associate PII and metadata to construct database 14 as shown in FIG. 2. Evidence engine 1102 then performs evidence summarization and results in email lookup and evidence database 18, also as shown in FIG. 2. Salacious engine 1104 then performs the profanity checks as described above. This data is then passed to ranking engine 1106 to perform ranking based on the true/false or Boolean flags of email lookup and evidence database 18. If it is determined that there is a tie between possible best email addresses at decision block 1108, then processing moves to tiebreaker engine 1110, which performs tie breaking as described above. Otherwise, processing moves directly to output database 22, containing a linkage between objects and the best email address for each object.

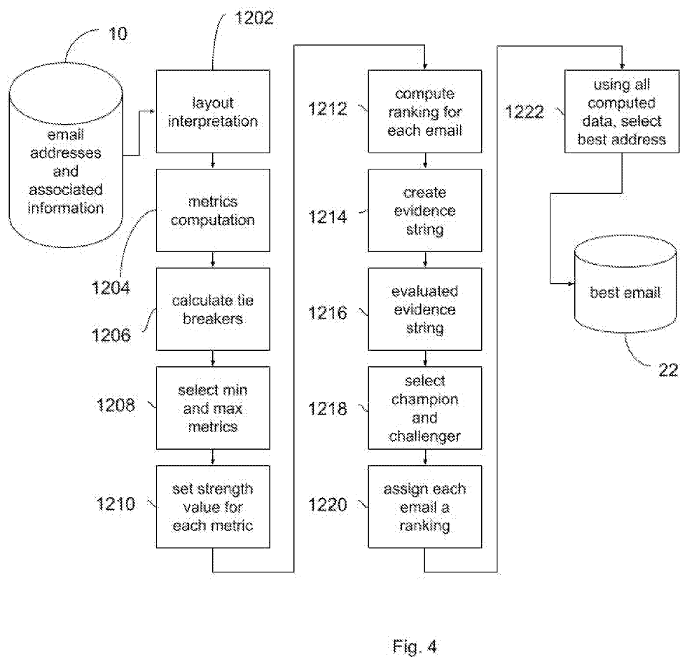

FIG. 4 depicts a method according to another implementation of the invention set forth herein. As with the method shown in FIG. 2, the process begins with input PII data (i.e., email address and associated information) 10. At layout interpretation step 1202, the system assembles the data to be used. The system will skip non-published entities at this step.

At step 1204, metrics computation, a number of metrics are calculated. The last seen dates (LSD)/recency metric is calculated as the ratio of sources that reported a particular email in the past reporting period (e.g., two years) against the total number of sources that reported the email. The record seen count metric is the number of records containing each email. The source count metric is the number of sources reporting each email. The URL provider count metric is the number of URL providers for each email. The URL provider strength metric is the number of URL providers weighted by the number of sources showing that URL as a provider for that email. The name component present in email metric is a flag that is set if the email contains name components belonging to the person. The emails in multiple domains metric is the number of times the local part of each email is repeated within the set of emails present in the household. The emails in household metric is the number of people within the household that share each email. The profanity metric is a flag that is set if the email is clean; emails are set to profane only if certain contains are met, such as, for example, the record seen count metric being greater than 25.

At calculate tie breakers step 1206, then tie breakers are applied if certain conditions are met. These conditions may be, for example, if certain emails rank closely in certain metrics. In this case, a handicap value is added to the record seen count metric in order to break possible ties. At select min and max metrics step 1208, the system computes minimum and maximum values for all metrics across all emails. At set strength value for each metric step 1210, the system performs a calculation to find the relative strength computation for each of the metric, that is, the ratio of the value of the metric versus its maximum value. In one example, the metric is identified as “strong” if the relative strength is 0.7 or larger; “medium” if the relative strength is less than 0.7 but 0.4 or greater; and “weak” otherwise. At compute ranking for each email step 1212, an overall rank computation is calculated as the sum of all metrics for each email.

At create evidence string step 1214, a string is created that represents the above calculations. In one example, a series of nine characters (0s and 1s) or binary digits each are associated with one of the previously described metrics: source count, record count, LSD, URL provider count, URL provider strength, name component present in email, emails in multiple domains, emails in household, and profanity. In each case, a “1” is present for the corresponding character if the metric is the maximum value across all emails, but “0” otherwise. Then at evaluate evidence string step 1216, a calculation is made to find, with respect to each character in the string, if the value is “1” and the sum of the string is equal to the maximum value of the sum of the string, then that email is picked as the challenger. This may be represented by:

If string[i]=‘1’ and sum(string)=max(sum(string)),then pick as challenger
Else, move to next character

In other words, if metric i is the maximum value for that metric across all emails and this email has the highest number of maximum metrics, this email is picked as a challenger.

At select champion and challenger step 1218, the challenger is picked as the email whose overall rank is higher than the overall rank for the champion by a set threshold T1 (the rank being as computed in step 1212). The challenger may also be chosen if the overall rank for the challenger is higher than the overall rank for the champion by a second threshold T2 and the system picked the same challenger in the past M months (where M may be any desired value). Note that T1, T2, and M are configurable values.

At assign each email a ranking step 1220, a partial ranking is performed by, for every email, assigning it to one of three buckets. The emails are placed in the strong bucket if the rank is greater than or equal to RT1; the medium bucket if the rank is less than RT1 but at least equal to RT2; and the weak bucket otherwise. RT1 and RT2 are also configurable. At using all computed data, select best address step 12222, each of the three buckets are sorted by strength. The email that is the best pick in the strong bucket will be the one that is chosen as the best email. This best email is then delivered as output 22.

The systems and methods described herein may in various embodiments be implemented by any combination of hardware and software. For example, in one embodiment, the systems and methods may be implemented by a computer system or a collection of computer systems, each of which includes one or more processors executing program instructions stored on a computer-readable storage medium coupled to the processors. The program instructions may implement the functionality described herein. The various systems and displays as illustrated in the figures and described herein represent example implementations. The order of any method may be changed, and various elements may be added, modified, or omitted.

A computing system or computing device as described herein may implement a hardware portion of a cloud computing system or non-cloud computing system, as forming parts of the various implementations of the present invention. The computer system may be any of various types of devices, including, but not limited to, a commodity server, personal computer system, desktop computer, laptop or notebook computer, mainframe computer system, handheld computer, workstation, network computer, a consumer device, application server, storage device, telephone, mobile telephone, or in general any type of computing node, compute node, compute device, and/or computing device. The computing system includes one or more processors (any of which may include multiple processing cores, which may be single or multi-threaded) coupled to a system memory via an input/output (I/O) interface. The computer system further may include a network interface coupled to the I/O interface.

In various embodiments, the computer system may be a single processor system including one processor, or a multiprocessor system including multiple processors. The processors may be any suitable processors capable of executing computing instructions. For example, in various embodiments, they may be general-purpose or embedded processors implementing any of a variety of instruction set architectures. In multiprocessor systems, each of the processors may commonly, but not necessarily, implement the same instruction set. The computer system also includes one or more network communication devices (e.g., a network interface) for communicating with other systems and/or components over a communications network, such as a local area network, wide area network, or the Internet. For example, a client application executing on the computing device may use a network interface to communicate with a server application executing on a single server or on a cluster of servers that implement one or more of the components of the systems described herein in a cloud computing or non-cloud computing environment as implemented in various sub-systems. In another example, an instance of a server application executing on a computer system may use a network interface to communicate with other instances of an application that may be implemented on other computer systems.

The computing device also includes one or more persistent storage devices and/or one or more I/O devices. In various embodiments, the persistent storage devices may correspond to disk drives, tape drives, solid state memory, other mass storage devices, or any other persistent storage devices. The computer system (or a distributed application or operating system operating thereon) may store instructions and/or data in persistent storage devices, as desired, and may retrieve the stored instruction and/or data as needed. For example, in some embodiments, the computer system may implement one or more nodes of a control plane or control system, and persistent storage may include the SSDs attached to that server node. Multiple computer systems may share the same persistent storage devices or may share a pool of persistent storage devices, with the devices in the pool representing the same or different storage technologies.

The computer system includes one or more system memories that may store code/instructions and data accessible by the processor(s). The system memories may include multiple levels of memory and memory caches in a system designed to swap information in memories based on access speed, for example. The interleaving and swapping may extend to persistent storage in a virtual memory implementation. The technologies used to implement the memories may include, by way of example, static random-access memory (RAM), dynamic RAM, read-only memory (ROM), non-volatile memory, or flash-type memory. As with persistent storage, multiple computer systems may share the same system memories or may share a pool of system memories. System memory or memories may contain program instructions that are executable by the processor(s) to implement the routines described herein. In various embodiments, program instructions may be encoded in binary, Assembly language, any interpreted language such as Java, compiled languages such as C/C++, or in any combination thereof; the particular languages given here are only examples. In some embodiments, program instructions may implement multiple separate clients, server nodes, and/or other components.

In some implementations, program instructions may include instructions executable to implement an operating system (not shown), which may be any of various operating systems, such as UNIX, LINUX, Solaris™, MacOS™, or Microsoft Windows™. Any or all of program instructions may be provided as a computer program product, or software, that may include a non-transitory computer-readable storage medium having stored thereon instructions, which may be used to program a computer system (or other electronic devices) to perform a process according to various implementations. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to the computer system via the I/O interface. A non-transitory computer-readable storage medium may also include any volatile or non-volatile media such as RAM or ROM that may be included in some embodiments of the computer system as system memory or another type of memory. In other implementations, program instructions may be communicated using optical, acoustical or other form of propagated signal (e.g., carrier waves, infrared signals, digital signals, etc.) conveyed via a communication medium such as a network and/or a wired or wireless link, such as may be implemented via a network interface. A network interface may be used to interface with other devices, which may include other computer systems or any type of external electronic device. In general, system memory, persistent storage, and/or remote storage accessible on other devices through a network may store data blocks, replicas of data blocks, metadata associated with data blocks and/or their state, database configuration information, and/or any other information usable in implementing the routines described herein.

In certain implementations, the I/O interface may coordinate I/O traffic between processors, system memory, and any peripheral devices in the system, including through a network interface or other peripheral interfaces. In some embodiments, the I/O interface may perform any necessary protocol, timing or other data transformations to convert data signals from one component (e.g., system memory) into a format suitable for use by another component (e.g., processors). In some embodiments, the I/O interface may include support for devices attached through various types of peripheral buses, such as a variant of the Peripheral Component Interconnect (PCI) bus standard or the Universal Serial Bus (USB) standard, for example. Also, in some embodiments, some or all of the functionality of the I/O interface, such as an interface to system memory, may be incorporated directly into the processor(s).

A network interface may allow data to be exchanged between a computer system and other devices attached to a network, such as other computer systems (which may implement one or more storage system server nodes, primary nodes, read-only node nodes, and/or clients of the database systems described herein), for example. In addition, the I/O interface may allow communication between the computer system and various I/O devices and/or remote storage. Input/output devices may, in some embodiments, include one or more display terminals, keyboards, keypads, touchpads, scanning devices, voice or optical recognition devices, or any other devices suitable for entering or retrieving data by one or more computer systems. These may connect directly to a particular computer system or generally connect to multiple computer systems in a cloud computing environment, grid computing environment, or other system involving multiple computer systems. Multiple input/output devices may be present in communication with the computer system or may be distributed on various nodes of a distributed system that includes the computer system. The user interfaces described herein may be visible to a user using various types of display screens, which may include CRT displays, LCD displays, LED displays, and other display technologies. In some implementations, the inputs may be received through the displays using touchscreen technologies, and in other implementations the inputs may be received through a keyboard, mouse, touchpad, or other input technologies, or any combination of these technologies.

In some embodiments, similar input/output devices may be separate from the computer system and may interact with one or more nodes of a distributed system that includes the computer system through a wired or wireless connection, such as over a network interface. The network interface may commonly support one or more wireless networking protocols (e.g., Wi-Fi/IEEE 802.11, or another wireless networking standard). The network interface may support communication via any suitable wired or wireless general data networks, such as other types of Ethernet networks, for example. Additionally, the network interface may support communication via telecommunications/telephony networks such as analog voice networks or digital fiber communications networks, via storage area networks such as Fibre Channel SANs, or via any other suitable type of network and/or protocol.

Any of the distributed system embodiments described herein, or any of their components, may be implemented as one or more network-based services in the cloud computing environment. For example, a read-write node and/or read-only nodes within the database tier of a database system may present database services and/or other types of data storage services that employ the distributed storage systems described herein to clients as network-based services. In some embodiments, a network-based service may be implemented by a software and/or hardware system designed to support interoperable machine-to-machine interaction over a network. A web service may have an interface described in a machine-processable format, such as the Web Services Description Language (WSDL). Other systems may interact with the network-based service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP). In some embodiments, network-based services may be implemented using Representational State Transfer (REST) techniques rather than message-based techniques. For example, a network-based service implemented according to a REST technique may be invoked through parameters included within an HTTP method such as PUT, GET, or DELETE.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. When a grouping is used herein, all individual members of the group and all combinations and sub-combinations possible of the group are intended to be individually included. When a range is stated herein, the range is intended to include all subranges and individual points within the range. All references cited herein are hereby incorporated by reference to the extent that there is no inconsistency with the disclosure of this specification.

1. A system for selecting an email address from a plurality of email addresses, comprising:
a memory storing sequences of instructions; and
a processor configured to execute the sequences of instructions which, when executed, causes the processor to perform:
searching an identity graph to return at least one item of personally identifiable information (PII) concerning an object;
associating at least one item of metadata with the at least one item of PII;
building an evidence database comprising the plurality of email addresses and, for each of the plurality of addresses, a plurality of flags indicative of email quality; and
ranking each of the plurality of email addresses based on the plurality of flags.

2. The system of claim 1, wherein the processor is further configured to perform determining if more than one of the plurality of email addresses is ranked equally, and if so performing a tie breaker routine to select a best email address from the plurality of email addresses.

3. The system of claim 2, wherein the processor is further configured to compare an email address with a base profanity list.

4. The system of claim 3, wherein the processor is further configured to compare the email address with the base profanity list by partial matching, or fuzzy matching, or phonetic matching, or some combination of partial matching, fuzzy matching, and phonetic matching.

5. A computer-implemented method for selecting an email address from a plurality of email addresses, comprising:
searching an identity graph to return at least one item of personally identifiable information (PII) concerning an object;
associating at least one item of metadata with the at least one item of PII;
building an evidence database comprising the plurality of email addresses and, for each of the plurality of addresses, a plurality of flags indicative of email quality; and
ranking each of the plurality of email addresses based on the plurality of flags.

6. The computer-implemented method of claim 5, further comprising the step of determining if more than one of the plurality of email addresses is ranked equally, and if so performing a tie breaker routine to select a best email address from the plurality of email addresses.

7. The computer-implemented method of claim 6, further comprising the step of comparing at least one of the plurality of email addresses with a base profanity list.

8. The computer-implemented method of claim 7, wherein the step of comparing at least one of the plurality of email addresses with a base profanity list performs partial matching, or fuzzy matching, or phonetic matching, or some combination of partial matching, fuzzy matching, and phonetic matching.

9. An email address selection system, comprising:
an identity graph;
a processor;
a non-transitory, computer-readable storage medium including computer instructions for:
searching an identity graph to return at least one item of personally identifiable information (PII) concerning an object;
associating at least one item of metadata with the at least one item of PII;
building an evidence database comprising the plurality of email addresses and, for each of the plurality of addresses, a plurality of flags indicative of email quality; and
ranking each of the plurality of email addresses based on the plurality of flags.

10. The email address selection system of claim 9, wherein the non-transitory, computer-readable storage medium further includes computer instructions for determining if more than one of the plurality of email addresses is ranked equally, and if so performing a tie breaker routine to select a best email address from the plurality of email addresses.

11. The email address selection system of claim 10, wherein the non-transitory, computer-readable storage medium further includes computer instructions for comparing at least one email address with a base profanity list.

12. The email address selection system of claim 11, wherein the non-transitory, computer-readable storage medium for comparing at least one email address with a base profanity list further includes computer instructions for partial matching, or fuzzy matching, or phonetic matching, or some combination of partial matching, fuzzy matching, and phonetic matching.

13. A system for selecting a best email address, comprising:
an identity graph comprising a plurality of records, wherein each record comprises a plurality of fields, and at least some of the plurality of fields in the plurality of records comprise data strings representing items of personally identifiable information (PII) that are not email addresses, and at least some of the plurality of fields in the plurality of records comprises data strings representing email addresses;
a metadata engine configured to associate at least one item of metadata with at least one of the plurality of items of PII;
an evidence engine configured to build an evidence database comprising the plurality of email addresses and, for each of the plurality of addresses, a plurality of flags indicative of email quality; and
a ranking engine configured to rank each of the plurality of email addresses based on the plurality of flags.

14. The system of claim 13, further comprising a tie breaker engine configured to determine if more than one of the plurality of email addresses is ranked equally, and if so performing a tie breaker routine to select a best email address from the plurality of email addresses.

15. The system of claim 14, further comprising a salacious engine configured to compare an email address with a base profanity list.

16. The system of claim 15, wherein the salacious engine is further configured to perform partial matching, or fuzzy matching, or phonetic matching, or some combination of partial matching, fuzzy matching, and phonetic matching.
